(19) United States
(12) Patent Application Publication
(10) Pub. No.: US 2002/0052049 A1
(43) Pub. Date: May 2, 2002

(54) Microfluidic separation device

(76) Inventors: Bernhard H. Weigl, Seattle, WA (US); Ronald L. Bardell, Redmond, WA (US)

Correspondence Address: TERRANCE A. MEADOR, GRAY CARY WARE & FREIDENRICH, LLP, 4365 EXECUTIVE DRIVE, SUITE 1100, SAN DIEGO, CA, 92121-2133, US

(21) Appl. No.: 09/956,591

(22) Filed: Sep. 18, 2001

Related U.S. Application Data
(60) Provisional application No. 60/233,396, filed on Sep. 18, 2000.

(51) Int. Cl. G01N 1/00; B01L 3/00

(52) U.S. Cl. 436/180; 422/100; 422/99; 422/102

(57) ABSTRACT

A device and method for performing a microfluidic process. A device includes a plurality of reservoirs, each connected a microfluidic channel. The microfluidic channel is arranged to use gravitational force to combine at least two fluids, from respective reservoirs of the plurality of reservoirs, when the respective reservoirs are positioned above an end of the microfluidic channel. The microfluidic channel is further arranged such that by rotation of the microfluidic channel, the direction of flow of the combined fluids is reversed to prolong the interaction between the fluids.

### RELATED APPLICATIONS

This application claims priority from U.S. Provisional Patent Application No. 60/233,396, filed Sep. 18, 2000, entitled “Microfluidic Systems and Methods”.

### BACKGROUND OF THE INVENTION

This invention relates to microfluidic structures. In particular, this invention provides microfluidic structures, devices and methods in which a microfluidic flow process can be conducted within a minimal space and without external drivers.

The field of microfluidics has become increasingly popular in recent years for testing, analysis and for performing a wide range of biological and/or physical processes. Using fabrication techniques and tools developed by the semiconductor industry, many applications are being developed that rely on microfluidics, such as intricate “lab on a chip” platforms. While systems have been developed to perform a variety of processes, several trends in the industry include shrinking the size of individual devices, and of increasing the scale and throughput of such devices by fabricating a larger number of smaller devices on a single platform.

Conventional microfluidic systems are however more constrained by physical dimensions than typical electronic systems. Fluid channels must be long enough to achieve a particular flow rate and/or volume for a desired process to take place among one or more fluid streams. Further, most microfluidic systems must rely on external drivers and pressure systems, such as electromechanical pressure generators, for moving or pushing fluids through channels. Channel length and drivers can occupy a large amount of space, which decreases the usable space needed for microfluidic processes and/or limits the number of systems that can be formed together.

### BRIEF DESCRIPTION OF THE DRAWING

FIG. 1 illustrates a microfluidic structure according to the invention.

FIG. 2 shows a device for performing a microfluidic process, in accordance with an embodiment of the invention.

FIG. 3 illustrates a flip-card including a microfluidic device.

### DETAILED DESCRIPTION OF THE PREFERRED EMBODIMENTS

This invention provides a device, and a method for using the same, for performing one or more microfluidic processes which minimizes channel length and functions without the need for external drivers.

As used herein, the term “microfluidic” generally refers to fluid containing structures having at least one internal cross-sectional dimension of between 0.1 and 500 micrometers, and/or conforming to the following formula:

0.1<(Smallest Cross-sectional dimension (in micrometers))×(viscosity of fluid)/(aqueous viscosity)<500.

The term microfluidic also refers to the uses and advantages of fluidic properties at such micro-scale. For example, U.S. patent application Ser. No. 09/415,404, filed Oct. 8, 1999, assigned to Micronics, Inc. of Redmond Wash., and incorporated by reference herein in its entirety for all purposes, teaches structures and techniques for certain types of microfluidic structures that do not use external drivers, i.e. microfluidic platforms that do not rely on externally-powered pumps or pressurization systems.

In one embodiment of the invention, a device for performing a microfluidic process includes a plurality of reservoirs, each connected a microfluidic channel arranged to use gravitational force to combine at least two fluids from respective reservoirs of the plurality of reservoirs, when the respective reservoirs are positioned above an end of the microfluidic channel. The use of gravity to move the fluids can be augmented with the use of capillary forces for specific sizes of microfluidic channels, and/or hydrostatic pressure within the fluids themselves, dependent at least in part on the size and configuration of the reservoirs.

In another embodiment, a system for performing a microfluidic process includes a microfluidic device, which in turn comprises a microfluidic channel having opposing ends. The microfluidic device further includes a plurality of reservoirs, at least one of which being connected to each opposing end of the microfluidic channel. The microfluidic channel is arranged to use internal gravitational force, capillary force, and/or hydrostatic pressure, to combine at least two fluids from respective at least two of the plurality of fluid reservoirs connected to one end of the microfluidic channel when the at least two reservoirs are positioned above the one end.

The microfluidic channel is further arranged to deposit the combined fluids into at least one other reservoir connected to the opposite end. The microfluidic device is configured to be flipped, rotated, tilted, or turned to position the at least one other reservoir above the opposite end of the microfluidic channel to reverse the direction of flow of the combined fluids.

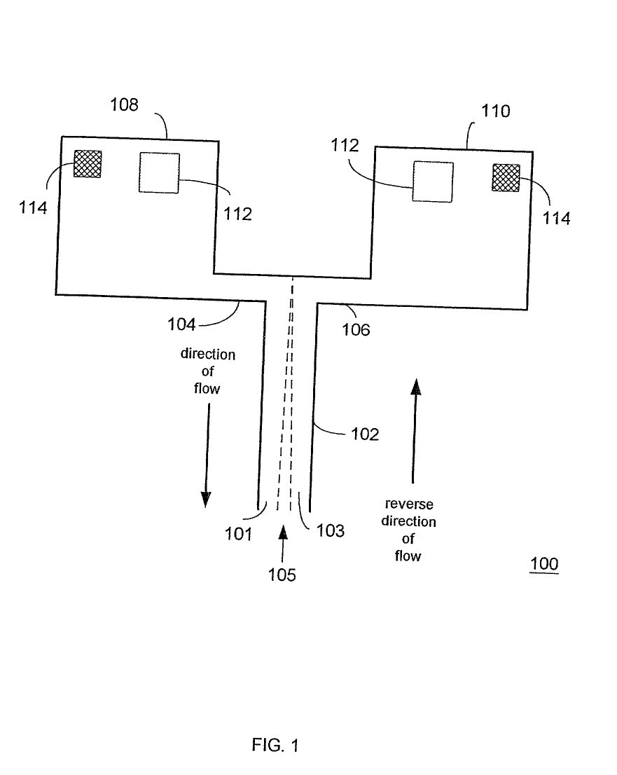

A specific, exemplary embodiment of the invention is described with reference to FIG. 1, which shows at least a portion of a microfluidic device. A microfluidic structure 100 includes a microfluidic channel 102 having at least two inlets 104 and 106. The microfluidic channel 102 preferably has at least one internal cross-sectional dimension that is between 0.1 and 500 microns, and more preferably between 1 and 100 microns. The at least two inlets 104 and 106 each receive a separate fluid stream from a respective reservoir 108, 110 connected thereto.

The first reservoir 108 is connected to the first inlet 104 and is configured to hold a first fluid. The second reservoir 110 is connected to a second inlet 106 and is configured to hold a second fluid. These connections form a passage through which fluids can flow into the microfluidic channel 102. The first and second fluids are combined in the microfluidic channel 102 in a partial or total parallel flow 101 and 103. The first and second reservoirs 108, 110 are shown in the figure as being squared or cubed, however, they may be of any shape, flatness, size or general orientation. The reservoirs 108 and 110 are also illustrated as largely separate, but may also be a formed as a compartment of one contiguous reservoir structure, separated by a network of inner walls or dam structures.

The reservoirs 108, 110 each include an outer wall. To aid the movement of fluids into the microfluidic channel 102, the outer wall of one or more reservoir can include an air vent 114, for displacing fluid with air. Further, the outer wall of one or more reservoir may include a septum 112, or other opening or aperture, for the injection of a fluid to be contained therein. The air vent 114 and/or septum 112 may be formed of a thin membrane that allows one-way injection of air and/or fluid. Alternatively, the air vent 114 and/or septum 112 may include a valve or other such mechanism, to mechanically open and close an opening for the air and/or fluid.

Within the combined flow 101, 103, an interaction region 105 is formed by the interaction between the first and second fluids. A microfluidic process can take place in the interaction region 105. Typically, in proportion to the time fluids flow in parallel in a common direction, the interaction region 105 grows gradually wider along the direction of flow. Thus, the longer the microfluidic channel 102, usually the wider the interaction region 105 will become.

The interaction region 105 in particular, and the microfluidic channel 102 in general, is configured to hosts a microfluidic process. The microfluidic process can be a separation or diffusion of a substance from one fluid into another fluid. Alternatively, the microfluidic process can be an extraction of a substance from one fluid to another fluid. Other microfluidic processes can include, without limitation, diffusion, reaction, or dilution, or thermal energy transfer and storage. The microfluidic process depends primarily on the molecular composition of the first and/or second fluids, and secondarily on environmental factors, such as, but not limited to, channel dimensions, temperature, channel materials, including interior and/or exterior channel coatings, flow rate, flow time, etc.

In a preferred embodiment, the first and second fluids enter the microfluidic channel 102 from the first and second reservoirs 108, 110 by the force of gravity and/or hydrostatic pressure from the fluids themselves, preferably when the structure is oriented such that the first and second reservoirs 108, 110 are positioned above at least a portion of the microfluidic channel 102, such as the end of the microfluidic channel to which the reservoirs are connected. The microfluidic channel 102 is shown as generally straight, however it can be curved, serpentine and/or angled, or oriented within in any plane.

In order to minimize the length of the microfluidic channel 102 to accomplish the desired process, the direction of the combined fluids 101, 103 can be reversed so that the interaction region 105 is effectively lengthened. One way of reversing the flow direction is by the structure 100 being flipped or rotated, preferably at about 180 degrees. The structure may be rotated at less or more than 180 degrees, or at any angle of rotation sufficient to accomplish a reverse flow.

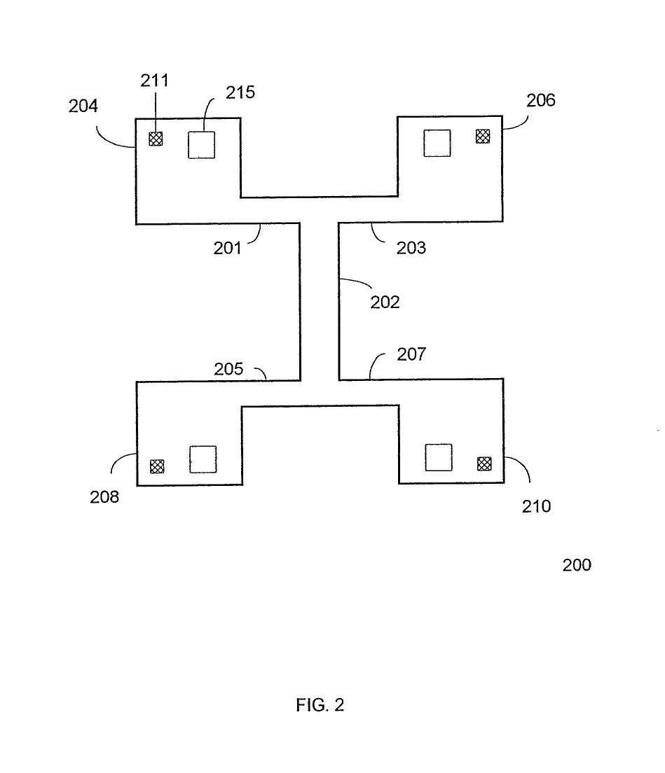

FIG. 2 shows a microfluidic device 200 that includes a microfluidic structure as described in FIG. 1, according to an alternative embodiment of the invention. The device 200 includes a microfluidic channel 202. The microfluidic channel 202 includes up to four inlets 201, 203, 205 and 207. A first and second reservoir 204, 206 are connected to one end of the microfluidic channel 202, preferably via respective inlets 201, 203. A third and fourth reservoir 208, 210 are connected to the opposite end of the microfluidic channel 202, preferably via respective inlets 205, 207. As described above, each of the reservoirs may be formed with an outer wall that includes an air vent 211 for displacing fluids with air and/or a septum 215 for receiving fluids.

In a preferred embodiment, only the first and second reservoirs 204, 206 each contain a fluid in an initial configuration. When the first and second reservoirs 204, 206 are positioned above at least a portion of the microfluidic channel 102, such as at least one end of the microfluidic channel 202, the respective first and second fluids will enter the microfluidic channel 202 with assistance of gravity, where the fluids will flow in parallel and/or combination in a first direction of flow and interact.

The device 200 may be flipped numerously to continually reverse the direction of the coincident flow, and prolong the interaction between the first and second fluids. Alternatively, the third and fourth reservoirs 208 and 210 may each collect a portion of the combined fluids. The portion may be entirely the first fluid, entirely the second fluid, or any proportional combination thereof. The device 200 may then be rotated or flipped to allow the collected, combined fluids in the third and fourth reservoirs 208, 210 to enter the microfluidic channel 202 in another flow, in a direction of flow that is opposite the first direction of flow.

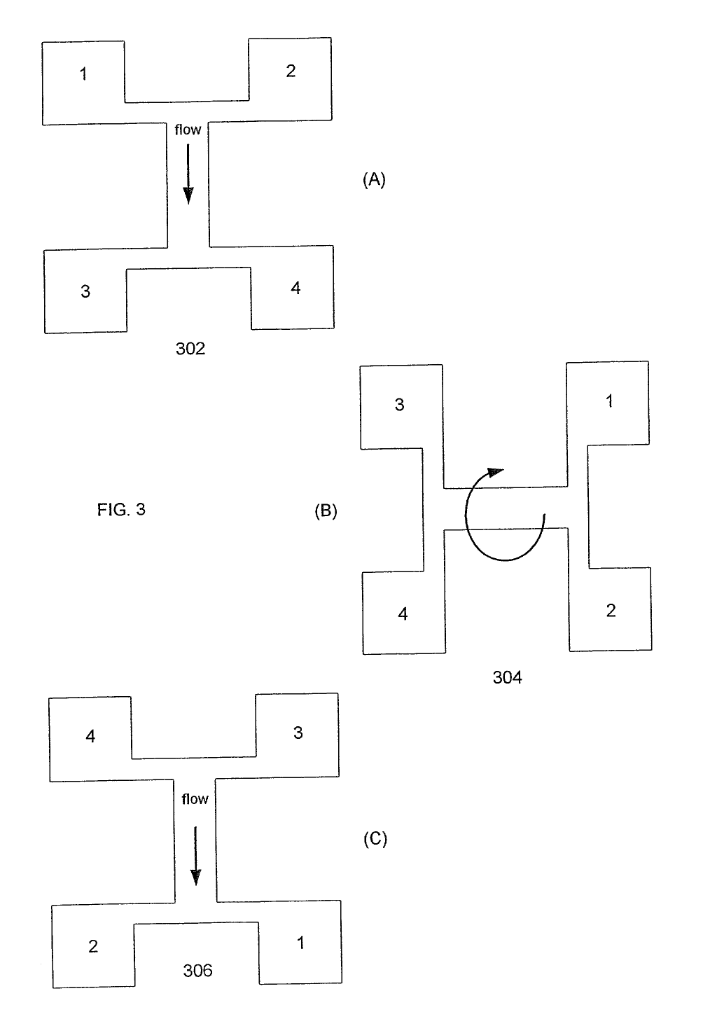

In still another embodiment, the third and/or fourth reservoirs can be used to introduce additional substances, fluids, agents, reactants, etc., to the first and/or second fluids, or combination thereof. It is within the scope of this invention that any number, size, or type of reservoirs can be used, and the device illustrated in FIG. 2 is exemplary only. Accordingly, a method of performing a microfluidic process will be described with reference to FIGS. 3(a)-(c) as an example only and not for means of limitation.

FIGS. 3(a)-(c) show a microfluidic device including a microfluidic channel having opposite ends, and two reservoirs connected to each end. FIG. 3(a) illustrates a first position 302 of the device in which first and second reservoirs, noted with a related number, are positioned above a microfluidic channel to which they are connected. Fluids contained within the respective first and second reservoirs enter the microfluidic channel, and are combined in a parallel flow. The flow can be made up of various combinations of the individual flows of both the first and second fluids. For example, the fluids may flow at different rates and/or have different volumes depending on the relative sizes of the reservoirs and/or inlets to the channel, or through the use of different internally-generated forces such as gravity, hydrostatic force, air venting and displacement, and capillary forces. A portion of the combined fluids forms an interaction region in which the separate fluids interact, and in which a microfluidic process is performed. The first position 302 is maintained for a predetermined time to partially or entirely complete the microfluidic process, in the indicated direction of flow.

At least a portion of the combined fluids will flow into third and fourth reservoirs, connected to and positioned below the opposite end of the microfluidic channel, in the first position 302. The device can then be rotated through an intermediate position 304, as shown in FIG. 3(b), to a second position 306 in which the third and fourth reservoirs are positioned above the opposite end, and the first and second reservoirs are positioned below the microfluidic channel. The fluid portions contained by the third and fourth reservoirs enter the microfluidic channel to continue the process, in a direction of flow that is opposite the direction of flow for the first position 302. The device can be flipped or rotated any number of times to accomplish the desired interaction or process.

Other arrangements, configurations and methods should be readily apparent to a person of ordinary skill in the art. Other embodiments, combinations and modifications of this invention will occur readily to those of ordinary skill in the art in view of these teachings. Therefore, this invention is to be limited only be the following claims, which include all such embodiments and modifications when viewed in conjunction with the above specification and accompanying drawings.

What is claimed is:

1. A device for performing a microfluidic process, comprising:
a plurality of reservoirs, each connected to a microfluidic channel arranged to use gravitational force to combine at least two fluids from respective reservoirs of the plurality of reservoirs, when the respective reservoirs are positioned above an end of the microfluidic channel.

2. The structure of claim 1, wherein the microfluidic channel uses hydrostatic pressure from the at least two fluids to maintain a flow of the combined fluids.

3. The structure of claim 1, wherein at least one reservoir has an outer wall which includes an air vent for displacing a fluid with air.

4. The structure of claim 1, wherein at least two reservoirs have an outer wall, each of which includes an air vent for displacing a fluid with air.

5. The structure of claim 1, wherein the microfluidic channel is arranged to rotate to reverse the direction of flow of the combined fluids.

6. The structure of claim 1, wherein the micro fluidic channel has opposite ends, and wherein at least one of the plurality of reservoirs is connected to each end.

7. The structure of claim 6, wherein the microfluidic channel is arranged to deposit the combined flow into at least one reservoir connected to an opposite end from which end the fluids enter the microfluidic channel.

8. The structure of claim 6, wherein at least two of the plurality of reservoirs is connected to each end of the microfluidic channel.

9. The structure of claim 7, wherein the microfluidic channel is arranged to rotate such that the at least one reservoir into which the combined flow deposits is positioned above the opposite end of the microfluidic channel to reverse the direction of flow of the deposited combined fluids.

10. The structure of claim 1, wherein the microfluidic channel is sized to perform a microfluidic process with the combined fluids.

11. The structure of claim 10, wherein the microfluidic process is at least one of a group of microfluidic processes comprising separation, extraction, reaction, dilution, thermal energy transfer, and thermal energy storage.

12. The structure of claim 1, wherein at least one reservoir includes a septum for receiving a fluid.

13. The structure of claim 1, wherein at least two reservoirs include a septum for receiving a fluid.

14. A system for performing a microfluidic process, comprising:
a device, comprising:
a microfluidic channel having opposing ends; and
a plurality of reservoirs, at least one of which being connected to each opposing end of the microfluidic channel,
the microfluidic channel arranged to use gravitational force to combine at least two fluids from respective at least two of the plurality of fluid reservoirs connected to one end of the microfluidic channel when the at least two reservoirs are positioned above the one end, and arranged to deposit the combined fluids into at least one other reservoir connected to the opposite end.

15. The system of claim 14, wherein when the device is flipped the at least one other reservoir is positioned above the opposite end of the microfluidic channel to reverse the direction of flow of the combined fluids through the microfluidic channel.

16. The system of claim 14, wherein each reservoir includes an outer wall.

17. The system of claim 16, wherein at least one outer wall includes an air vent for displacing a fluid with air.

18. The system of claim 19, wherein at least one outer wall includes a septum for receiving a fluid.

19. The system of claim 14, wherein the device includes two reservoirs connected to each end of the microfluidic channel.

20. The system of claim 19, wherein each reservoir includes an outer wall, and wherein each outer wall includes an air vent for displacing a fluid with air, and a septum for receiving the fluid.

21. In combination with a device including a microfluidic channel having opposing ends and a plurality of reservoirs, at least one of which being connected to each opposing end of the microfluidic channel, a method for performing a microfluidic process, comprising:
orienting the device to position at least two reservoirs above one end of the microfluidic channel; and
combining at least two fluids from the respective at least two reservoirs in a gravity-fed flow.

22. The method of claim 21, further comprising depositing the combined fluids into at least one other reservoir connected to the opposite end of the microfluidic channel.

23. The method of claim 22, further comprising flipping the device to orient the at least one other reservoir above the opposite end of the microfluidic channel to reverse the direction of flow of the combined fluids.

24. The method of claim 23, further comprising continuing flipping the device until the microfluidic process is complete.
